(19) United States
(12) Patent Application Publication
(10) Pub. No.: US 2025/0018362 A1
(43) Pub. Date: Jan. 16, 2025

(54) OFF-GAS FILTER FOR CAPTURING VOLATILE ELEMENTS

(71) Applicant: BATTELLE SAVANNAH RIVER ALLIANCE, LLC, AIKEN, SC (US)

(72) Inventors: MATTHEW S. WILLIAMS, AIKEN, SC (US); DAVID T. HERMAN, AIKEN, SC (US)

(21) Appl. No.: 18/352,396

(22) Filed: Jul. 14, 2023

(51) Int. Cl. B01J 20/10; B01D 53/04; B01J 20/06; B01J 20/26; B01J 20/28; B01J 20/30; B29C 64/135; B33Y 10/00; B33Y 70/10; B33Y 80/00; G21F 9/02

(52) U.S. Cl. CPC B01J 20/10; B01D 53/04; B01J 20/06; B01J 20/261; B01J 20/262; B01J 20/28004; B01J 20/28026; B01J 20/3007; B01J 20/3078; B01J 20/3085; B29C 64/135; B33Y 10/00; B33Y 70/10; B33Y 80/00; G21F 9/02; B01D 2253/106; B01D 2253/112; B01D 2253/25; B01D 2253/304; B01D 2257/60; B29K 2033/08; B29K 2077/00; B29K 2105/251

(57) ABSTRACT

An off-gas filter and a method for forming an off-gas filter are provided. The off-gas filter comprises a polymer composition that comprises a polymeric matrix and a cesium sorbent dispersed within the matrix. The method comprises 3D printing the off-gas filter.

### STATEMENT REGARDING FEDERALLY SPONSORED RESEARCH OR DEVELOPMENT

This invention was made with Government support under Contract No. 89303321CEM00080, awarded by the U.S. Department of Energy. The Government has certain rights in the invention.

### BACKGROUND

Nuclear energy production and defense applications create large quantities of radioactive waste, which is typically stored and then treated. A significant component of the radioactivity in the stored waste comes from 137Cs, which emits high-activity gamma radiation. Nuclear waste may be treated by various methods, such as vitrification for oxides or downblending in the case of metallic components. Waste vitrification technology involves mixing a chemically characterized, aqueous waste stream with chemical oxidizers and reducers, specific metal oxides and metal carbonates, and a glass-forming frit to produce a slurry that is fed to a melter in which the slurry is incorporated into the melt pool. The melter is continuously bubbled by forcing gas through submerged pipes in the molten pool to increase the melt rate. The volatile components are driven into off-gas by heat, requiring a complex off-gas system to treat the melter off-gas prior to discharge. In the case of downblending metallic components or oxides easily reduced to metallic forms, the final wasteform is a monolithic metal ingot. The dry waste materials are blended with a diluent such as stainless steel, a reducing agent, and an oxidation scavenger and melted into a single, homogeneous ingot in a furnace such as an induction coil. Once cooled, the radionuclides are diluted such that nuclear proliferation options are restricted. During the melting process, volatile species such as ¹³⁷Cs are evolved and must be mitigated by a complex offgas system prior to discharge.

The off-gas from the various forms of waste treatment typically contains a portion of radioactive nuclides, including species such as cesium, mercury, iodine, and technetium, which need to be separated from the gas effluent stream. Currently, such gaseous radionuclides can be condensed or scrubbed from the off-gas stream into a liquid waste or recycle stream which requires further treatment.

There are known methods for removal of cesium from liquid streams. For example, liquid waste streams can be passed through columns packed with sorbent materials which selectively absorb or adsorb cesium while allowing other components to pass through. Various cesium sorbents include crystalline silicotitanate, resorcinol formaldehyde, potassium cobalt hexacyanoferrate, and organic ion-exchange resins.

However, it would be useful to be able to sequester cesium directly from the off-gas stream in a dry process rather than from a liquid stream, such as a condensate or scrubber stream. As such, there is a need for an off-gas filter capable of removing cesium from a vapor stream.

### SUMMARY

In one aspect, an off-gas filter is provided. The filter comprises a polymer composition that comprises a polymeric matrix and a cesium sorbent dispersed within the matrix.

In another aspect, a system for removal of cesium from radioactive waste is provided. The system comprises a radioactive waste material, an off-gas stream containing cesium volatilized from the radioactive waste material, and a filter. The filter comprises a polymer composition that comprises a polymeric matrix and a cesium sorbent dispersed within the matrix.

In another aspect, a method for producing an off-gas filter is provided. The method comprises 3D printing the filter from a polymer composition comprising a polymeric matrix and a cesium sorbent dispersed within the matrix.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIGS. 1A-1B illustrate a stereolithography (SLA) 3D printing system according to some embodiments of present disclosure.

FIG. 2 illustrates a selective laser sintering (SLS) 3D printing system according to some embodiments of the present disclosure.

FIG. 3 illustrates an off-gas filter according to some embodiments of the present disclosure.

FIG. 4 illustrates a radioactive waste off-gas treatment system according to some embodiments of the present disclosure.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to an off-gas filter. The off-gas filter is capable of removing cesium from a vapor stream and comprises a polymer composition which comprises a polymer matrix and a cesium sorbent dispersed within the matrix. The filter can be formed by 3D printing, which allows for wide flexibility in the structure of the filter. For instance, the filter can be formed with intricate filtration structures designed to provide a high surface area for maximum contact between the polymer composition, and thus the sorbent material, and the volatilized cesium.

Advantageously, the filter can be used for dry filtration directly in the off-gas line. For example, it can be designed to fit in-line in off-gas processing lines. Alternatively, a specific vessel designed to hold the filter component may be placed in-line in an off-gas processing line. As another advantage, the filter is relatively easily disposable as a solid wasteform.

### I. Polymer Composition

### A. Polymer Matrix

While any polymeric resin can be used as the polymer matrix in the composition, it is preferred that the resin is suitable for 3D printing in order to have maximum flexibility with regard to the structure of the filter. As such, the resin is preferably suitable for use with stereolithography (SLA) printers or selective laser sintering (SLS) printers.

In stereolithography, solid objects are created by successively forming thin layers of a curable polymer resin (i.e., a photopolymer resin), typically first onto a build platform and then one on top of another. Exposure to actinic radiation cures a thin layer of liquid resin, which causes it to harden and adhere to previously cured layers or to the bottom surface of the build platform.

In stereolithography, the liquid resin mixture typically comprises a polymeric precursor and a photoinitiator configured to initiate formation of a polymeric material from the polymeric precursor upon irradiation.

The photosensitive resin may comprise one or more photosensitive monomers or oligomers capable of being polymerized by light, typically having a wavelength of between 350 and 450 nm.

The photopolymer can be a commercial photopolymer or a photopolymer formulated by mixing monomers, oligomers, photoinitiators, and other additives such as photo-absorbers, dyes, and inhibitors. The monomer/oligomer can be (but is not restricted to) an acrylate-based monomer, an acrylamide-based monomer, a polyether, an acryloyl morpholine, a polyethylene glycol, an epoxy-based monomer, or a combination of these and other monomers.

Examples of acrylate-based monomers are acrylates (e.g., behenyl acrylate, or 2-hydroxyethyl acrylate), diacrylates (e.g., polyethylene glycol diacrylate), triacrylates (e.g., trimethylolpropane triacrylate), tetraacrylates (e.g., di(trimethylolpropane) tetraacrylate), and methacrylates (e.g., (hydroxyethyl) methacrylate).

An example of a polyether is polypropylene glycol.

Examples of acrylamide-based monomer are acrylamide, and N,N′-methylenebisacrylamide.

An example of an epoxy-based monomer is epoxy cyclohexane carboxylate.

In some embodiments, the photosensitive resin may comprise one or more photosensitive acrylate or methacrylate monomers or oligomers.

The photoinitiator can be (but is not restricted to) peroxides (e.g. benzoyl peroxide), nitrogen dioxide, camphorquinone, molecular oxygen, azobisisobutyronitrile, lithium phenyl-2,4,6-trimethylbenzoylphosphinate, benzoin methyl ether, 2,2-dimethoxy-2-phenylacetophenone, 2-hydroxy-2-methylphenylpropane-1-one, a-hydroxy-acetophenone, bis(2,6-dimethoxybenzoyl)-2,4,4-trimethylpentylphosphine oxide, 2-hydroxy-2-methyl-1-phenyl-propan-1-one, 2,4,6-trimethylbenzoyldiphenylphosphine oxide, or a combination of these and other photoinitiators.

Suitable photoinitiators may be selected from the group consisting of 2,2-dimethoxy-2-phenylacetophenone, 2-hydroxy-2-methylpropiophenone, camphorquinone, bis(2,4,6-trimethylbenzoyl)-phenylphosphineoxide, benzophenone, benzoyl peroxide, dicumyl peroxide, 2,2′-azobisisobutyronitrile, oxygen, nitrogen dioxide, and combinations or derivatives thereof. Other photoinitiators or thermal free-radical initiators may also be utilised.

In some embodiments, the photoinitiator is present from about 0.001 wt. % to about 15 wt. % of the photopolymer. In various embodiments, the photoinitiator may be present in an amount from about 0.002 to about 10 wt. %, from about 0.01 to about 5 wt. %, or from about 0.1 to about 3 wt. % of the polymer matrix.

Selective laser sintering (SLS) involves the use of a high power laser (for example, a carbon dioxide laser) to fuse small particles of plastic, metal, ceramic, or glass powders into a mass that has a desired three-dimensional shape. The laser selectively fuses powdered material by scanning cross-sections generated from a 3-D digital description of the part (for example from a CAD file or scan data) on the surface of a powder bed. After each cross-section is scanned, the powder bed is lowered by one layer thickness, a new layer of material is applied on top, and the process is repeated until the part is completed.

Polymers suitable for SLS techniques can include crystalline or semi-crystalline polymers. Some examples of semi-crystalline polymers include polyamides (PAS), such as polyamide 11 (PA 11/nylon 11), polyamide 12 (PA 12/nylon 12), polyamide 12-GB (PA 12-GB/nylon 12-GB), polyamide 6 (PA 6/nylon 6), polyamide 4,6 (PA 4,6/nylon 4,6), polyamide 13 (PA 13/nylon 13), polyamide 6,13 (PA 6,13/nylon 6,13), polyamide 8 (PA 8/nylon 8), polyamide 9 (PA 9/nylon 9), polyamide 66 (PA 66/nylon 66), polyamide 612 (PA 612/nylon 612), polyamide 812 (PA 812/nylon 812), polyamide (PA 912/nylon 912), etc. Polyamide 12-GB refers to a polyamide 12 including glass beads or another form of glass disclosed herein (mixed therewith or encapsulated therein). Other examples of crystalline or semi-crystalline polymers suitable for use as the polymer include polyethylene, polypropylene, and polyoxomethylene (i.e., polyacetals). Still other examples of suitable polymers include polystyrene, polycarbonate, polyester, polyurethanes, other engineering plastics, and blends of any two or more of the polymers listed herein. One example of a suitable polyester is polybutylene terephthalate (PBT).

In some examples, the polymer may be a thermoplastic elastomer. Some examples of thermoplastic elastomers include a thermoplastic polyamide (TPA), a thermoplastic polyurethane (TPU), a styrenic block copolymer (TPS), a thermoplastic polyolefin elastomer (TPO), a thermoplastic vulcanizate (TPV), and a thermoplastic copolyester (TPC). In one embodiment, the thermoplastic elastomer is a thermoplastic polyamide. Thermoplastic polyamide elastomers are thermoplastic elastomer block copolymers based on nylon and polyethers or polyesters. Examples of TPA elastomers include polyether block amide elastomers. Polyether block amide elastomers may be obtained by the polycondensation of a carboxylic acid terminated polyamide (PA 6, PA 11, PA 12) with an alcohol terminated polyether (e.g., polytetramethylene glycol (PTMG), polyethylene glycol (PEG), etc.). In another example, the thermoplastic elastomer is a thermoplastic polyurethane. Thermoplastic polyurethane elastomers may be obtained by reaction of: (i) diisocyanates with short-chain diols (so-called chain extenders) and/or (ii) diisocyanates with long-chain diols.

In some examples, the polymer may be in the form of a powder. In other examples, the polymer may be in the form of a powder-like material, which includes, for example, short fibers having a length that is greater than its width. In some examples, the powder or powder-like material may be formed from, or may include, short fibers that may, for example, have been cut into short lengths from long strands or threads of material.

The polymer may be made up of similarly sized particles and/or differently sized particles. In some embodiments, the average particle size of the polymer ranges from about 2 μm to about 200 μm, and in some embodiments, from about 10 μm to about 110 μm. The term “average particle size”, as used herein, may refer to a number-weighted mean diameter or a volume-weighted mean diameter of a particle distribution.

### B. Cesium Sorbent

The cesium sorbent can be any known sorbent capable of incorporating into a polymer matrix. Suitable cesium sorbents include inorganic particulate materials such as aluminosilicate compounds and zeolites including but not limited to analcime, chabazite, clinoptilolite, heulandite, natrolite, phillipsite, stilbite, titanium-coated zeolite lonsiv TIE-96, Zeolite type 13X, Zeolite 10A, Zeolite 100A, minerals and several types of clays including but not limited to montmorillonite, vermiculite, micas, muscovite, illite, fluorite, chlorite, microline, pyrite, serpentine, apatite, hydroxyapatite, hermatite, magnetite, dolomite, alumina, quartz, apatite, calcite and gibbsite, manganese dioxide, iron oxides, biotite, kaolinite, augite, hornblende, enstatite, anorthite, albite, microline, orthoclase, titanate, monosodium titanate, manganese oxide, crown ethers including but not limited to 18-crown-6 and 15-crown-5, activated carbon, crystalline silicotitanate, pillared clays, ammonium molybdophosphate, zinc hexacyanoferrates (II), copper hexacyanoferrates (II), cobalt hexacyanoferrates (II), nickel hexacyanoferrates (II), ferric ferrocyanides (insoluble form), potassium iron ferrocyanides, potassium cobalt hexacyanoferrates, iron (III) hexacyanoferrates (II) or a mixture of two or more thereof.

Crystalline silicotitanate (CST) is particularly preferable due to its excellent Cs selectivity in the presence of high concentrations of competing ions and its stability in extreme radiation fields. A commercially available crystalline silicotitanate is IONSIV® IE-911 composed of zirconium-hydroxide-bound crystalline silicotitanate.

Preferably, the cesium sorbent is in the form of a particulate material having a particle size of about 45 μm or less. For example, the cesium sorbent can have a particle size from about 5 μm to about 45 μm, in some embodiments from about 10 μm to about 40 μm, and in some embodiments, from about 20 μm to about 35 μm. In one embodiment, crystalline silicotitanate is ground into a fine powder and sieved to obtain particles of the desired size.

The loading of the sorbent in the polymer matrix can be varied as necessary. The loading must be high enough to ensure sufficient sorbent at the surface of filtration components but low enough to ensure sufficient polymer strength to maintain the structural integrity of the filter. Additionally, the higher the sorbent loading, the more Cs will be taken up, and the hotter (radioactivity-wise) the sorbent material will be. The hotter the material, the more shielding required. Depending on the specific binding activity of the sorbent, the ability of the polymer composition to remain structurally intact, and the amount of shielding available, the loading may vary. In some embodiments, the sorbent can be present in an amount from about 1 wt. % to about 50 wt. % of the composition.

### C. Other Components

Other optional components may be incorporated into the polymer composition as well. Such components may include additives such as a filler, an antioxidant, a whitener, an antistatic agent, a flow aid, or a combination thereof. It is to be understood that these additives are selected to be thermally stable (i.e., will not decompose) at the 3D printing temperatures.

When the polymer matrix is formed from a liquid precursor, a dispersant may also be included to aid in dispersion of the cesium sorbent within the liquid precursor. Dispersants may include a polysorbate compound, such as a polyoxoethylene sorbitol ester, or polyethylene glycol sorbitan monolaurate, a polyalkylene glycol (e.g., polypropylene glycol), alkyl gallate molecules (e.g., propyl gallate, butyl gallate, octyl gallate, lauryl gallate, octadecyl gallate), sodium dodecyl sulfate, cetyltrimethyl ammonium bromide, polyoxy ethylene octylphenyl ether, polyacrybc acid-co-itaconic acid, sodium pyrophosphate, sodium citrate, sodium carbonate, diammonium hydrogen citrate, or a combination of these and other dispersants.

Additionally, when the polymer is a photopolymer, a photoinhibitor may also be present in the composition. Photoinhibitors may include one or more of: zinc dimethyl dithiocarbamate: zinc dimethyl dithiocarbamate; zinc diethyl dithiocarbamate; zinc dibutyl dithiocarbamate; nickel dibutyl dithiocarbamate; zinc dibenzyl dithiocarbamate; tetramethylthiuram disulfide; tetraethylthiuram disulfide (TEDS); tetramethylthiuram monosulfide; tetrabenzylthiuram disulfide; tetrisobutylthiuramdisulfide; dipentamethylene thiuram hexasulfide; N.N′-dimethyl N, N′-di(4-pyridinyl) thiuram disulfide; 3-Butenyl 2-(dodecylthiocarbonothioylihio)-2-methylpropionate; 4-Cyano-4-[(dodecylsulfanylthiocarbonyl) sulfanyl]pentanoic acid; 4-Cyano-4-[(dodecylsulfanylthiocarbonyl) sulfanyl]pentanol; Cyanomethyl dodecyl trithiocarbonate; Cyanomethyl [3-(trimethoxysilyl) propyl] trithiocarbonate; 2-Cyano-2-propyl dodecyl trithiocarbonate; S,S-Dibenzyl trithiocarbonate; 2-(Dodecylthiocarbonothioylthio)-2-methylpropionic acid; 2-(Dodecylthiocaibonothioylthio)-2-methylpropionic acid N-hydroxysuccinimide; Benzyl 1H-pyrrole-1-carbodithioate;Cyanomethyl diphenylcarbamodithioate; Cyanomethyl methyl(phenyl) carbarnodithioate; Cyanomethyl methyl (4-pyridyl) carbamodithioate; 2-Cyanopropan-2-yl N-methyl-N-(pyridin-4-yl) carbamodithioate; Methyl 2-[methyl (4-pyridinyl) carbamoihioylthio]propionate; 1-Succinimidyl-4-cyano-4-[N-methyl-N-(4-pyridyl) carbamothioylthio]pentanoate; Benzyl benzodithioate; Cyanomethyl benzodithioate;4-Cyano-4-(phenylcarbonothioylthio) pentanoie acid; 4-Cyano-4-(phenylcarbonothioylthio) pentanoic acid N-succinimidylester; 2. Cyano-2-propyl benzodithioate; 2-Cyano-2-propyl 4-cyanobenzodithioate; Ethyl 2-(4-methoxyphenylcarbonothioylthio)acetate; 2-Phenyl-2-propyl benzodithioate; Cyanomethyl methyl (4-pyridyl) carbamodithioate; 2-Cyanopropan-2-yl N-methyl-N-(pyridin-4-yl) carbamodithioate; Methyl 2-[methyl (4-pyridinyl) carbamothioylthio]propionate; 1,1′-Bi-1H-imidazole; and functional variants thereof.

The polymer composition may also contain other sorbents in addition to the cesium sorbent. For example, the composition can contain sorbents which selectively sequester other elements of interest, such as mercury. Such other sorbents can be any known in the art which can be incorporated into the polymer composition. In some embodiments, the additional sorbent may include monosodium titanate (MST) and/or amorphous peroxotitanate (APT).

### II. Formation

In some embodiments, the polymer matrix is formed by photocuring a liquid resin precursor (e.g., in a stereolithography process). The cesium sorbent can be incorporated into the liquid resin precursor by mixing the finely powdered sorbent into the liquid resin precursor and agitating the mixture (e.g., by using a low-energy mill or shaker). The agitation method should be low energy so as to avoid degradation of the sorbent structures or the polymer.

Upon selectively curing the resin precursor to form the filter, the sorbent powder will be locked into the cured polymer matrix. A portion of the sorbent powder will be exposed on the surface of the cured polymer structures, which will be exposed directly to the vapor stream containing volatilized cesium.

In other embodiments, the polymer matrix is formed by fusing a polymer powder (e.g., in an SLS process). In such embodiments, the cesium sorbent powder can be blended with the polymer powder and the mixed powder can be used in a 3D printer. To aid in uniformly blending the powders together, similar low-energy agitation methods may be used. Alternatively, the cesium sorbent particles can be encapsulated by the polymer to form a powder of encapsulated particles, which can then be used directly in an SLS 3D printer.

Upon selectively sintering the polymer powder to form the filter, the sorbent powder will be locked into the fused polymer matrix. A portion of the sorbent powder will be exposed on the surface of the cured polymer structures, which will be exposed directly to the vapor stream containing volatilized cesium.

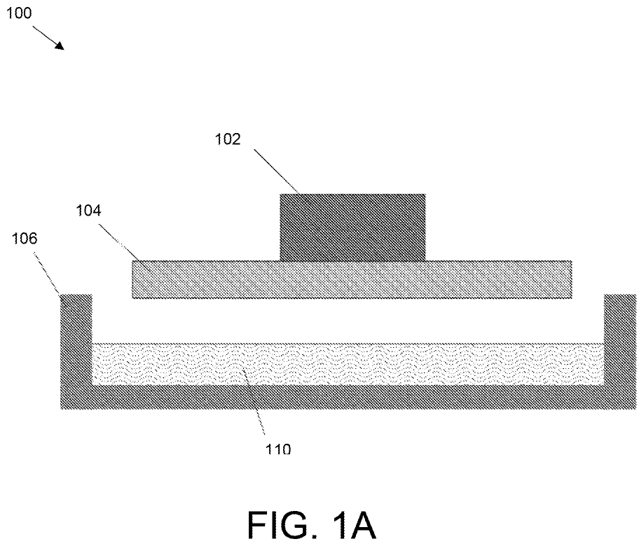

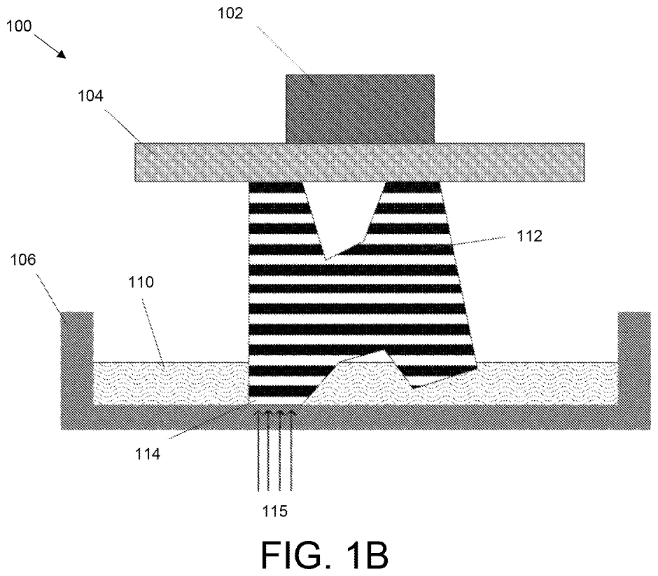

A typical stereolithography process is depicted in FIGS. 1A-1B. Illustrative stereolithographic printer 100 forms an article in a downward facing direction on a build platform such that layers of the part are formed in contact with a surface of a container in addition to a previously cured layer or the build platform. In the example of FIGS. 1A-1B, stereolithographic printer 100 comprises build platform 104, container 106 and liquid resin 110. A downward facing build platform 104 opposes the floor of container 106, which contains a photopolymer resin 110. FIG. 1A represents a configuration of stereolithographic printer 100 prior to formation of any layers of an object on build platform 104. The photopolymer resin 110 may be the composition as discussed throughout this disclosure.

As shown in FIG. 1B, an article 112 may be formed layer-wise, with the initial layer attached to the build platform 104. In FIG. 1B, the layers of the part 112 are each formed from the same material but are shown in alternating colors merely to visually distinguish them in this example. The container's base surface may be transparent to actinic radiation, such that radiation can be targeted at portions of the thin layer of liquid photocurable resin resting on the base surface of the container. Exposure to actinic radiation 115 cures a thin layer of the liquid resin, which causes it to harden. The layer 114 is at least partially in contact with both a previously formed layer and the surface of the container 106 when it is formed. The top side of the cured resin layer typically bonds to either the bottom surface of the build platform 104 or with the previously cured resin layer in addition to the transparent floor of the container. In order to form additional layers of the part subsequent to the formation of layer 114, any bonding that occurs between the transparent floor of the container and the layer must be broken. For example, one or more portions of the surface (or the entire surface) of layer 114 may adhere to the container such that the adhesion must be removed prior to formation of a subsequent layer.

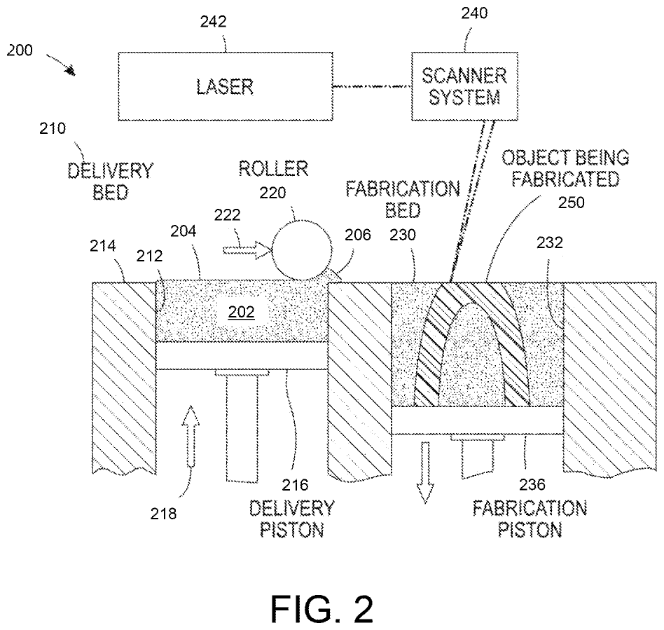

FIG. 2 depicts an illustrative SLS 3D printer 200. The printer 200 may include a delivery bed 210 defined by one or more sidewalls 212 and a delivery piston 216. Polymer particles 202 may be loaded into the delivery bed 210 in dry powder and/or paste form. Once loaded, the upper surface 204 of the particles 202 may be even with or below the upper surface 214 of the sidewall 212. The delivery piston 216 may then move upwards in the direction of arrow 218 until the upper surface 204 of the polymer particles 202 is even with or above the upper surface 214 of the sidewall 212.

A transfer member (e.g., a roller) 220 may then transfer a portion 206 of the polymer particles 202 above the upper surface 214 of the sidewall 212 from the delivery bed 210 into a fabrication bed 230 (e.g., in the direction of the arrow 222). The fabrication bed 230 may be defined by one or more sidewalls 232 and a fabrication piston 236. The transferred portion 206 of the polymer particles 202 may form a first layer in the fabrication bed 230 that has a thickness from about 10 μm to about 50 μm, about 50 μm to about 100 μm, about 100 μm to about 250 μm, or any other suitable thickness.

A scanning system 240 may scan the polymer particles 202 in the first layer, and a laser 242 may then sinter the first layer in response to the scan results. The laser 242 may be a continuous wave laser or a pulse laser. When the laser 242 is a pulse laser, the pulse length and intervals may be adjusted for proper sintering. The sintering may take place at a temperature less than or equal to about 200° C., a temperature less than or equal to about 150° C., less than or equal to about 125° C., or less than or equal to about 100° C.

Once the first layer has been sintered in the fabrication bed 230 the delivery piston 216 may then move upwards again in the direction of the arrow 218 until the upper surface 204 of the polymer particles 202 is again even with or above the upper surface 214 of the sidewall 212 of the delivery bed 210. The fabrication piston 236 may move downwards. The transfer member 220 may then transfer another portion of the polymer particles 202 that are above the upper surface 214 of the sidewall 212 from the delivery bed 210 into the fabrication bed 230 to form a second layer that is on and/or over the first layer. The laser 242 may then sinter the second layer. This process may be repeated until the desired 3D object is produced. In the described process, the polymer particles may comprise a combination of the polymer matrix powder and the cesium sorbent particles, as described herein.

The three-dimensional printer 200 as shown in FIG. 2 is exemplary only and any type of SLS printer can be employed.

### III. Off-Gas Filter

The off-gas filter is not limited in its structure. The flexibility of the 3D printing methods described above allow for intricate filtration structures intended to create a tortuous flow path for the vapor as it passes through the filter. Preferred filter structures aim to maximize contact between the vapor and the walls and other structures formed from the polymer composition. Preferably, the filter contains thin walls to maximize the specific surface area of the filter. For example, the filter may comprise structural components having walls of a thickness from about 1 mm to about 5 mm and in some embodiments, from about 1 mm to about 3 mm. The outer shape of the filter may be cylindrical so that it can be fitted into a pipe within an off-gas treatment system. For example, the filter may be designed to fit within a 6-inch pipe or the like.

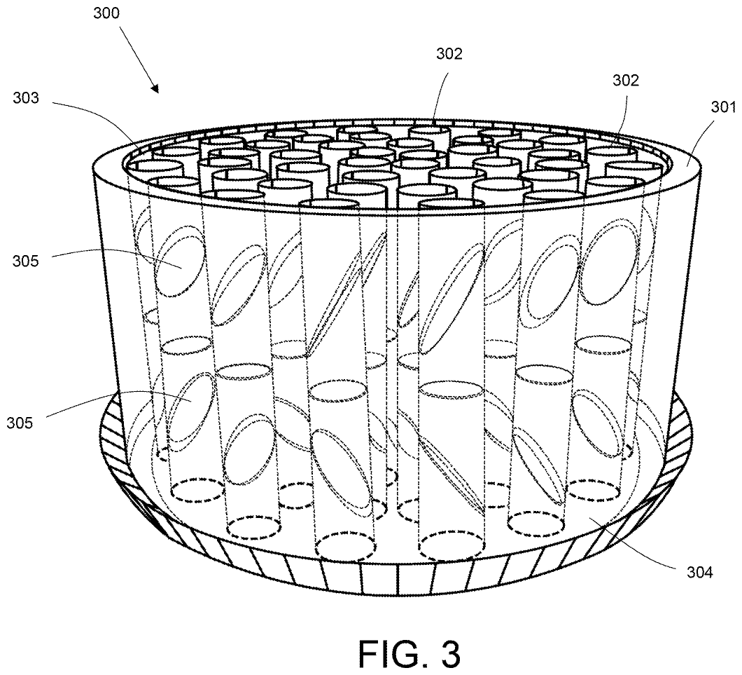

One embodiment of a suitable filter is shown in FIG. 3. As shown in FIG. 3, the filter 300 may comprise a cylindrical outer enclosure 301 and a plurality of tubes 302 extending between a top plate 303 and a bottom plate 304. Each tube comprises angled baffles 305. As shown, each tube comprises two baffles 305, each at opposite angles. As such, the filter 300 is configured such that vapor travels through the tubes 302 and around the baffles 305 within the tubes in order to create a turbulent flow. The tube walls and baffles 305 may be formed from the polymer composition including the cesium sorbent to sequester cesium from the vapor stream. The outer enclosure 301 and top and bottom plates 303 and 304 may or may not be formed from the same polymer composition.

It should be understood that the filter shown in FIG. 3 is an exemplary embodiment only, and there are many other filter structures that can be formed using the polymer composition described herein.

### IV. Radioactive Waste Treatment System

The filter described above may be incorporated into a radioactive waste treatment system. The system can comprise radioactive waste material, an off-gas stream containing cesium vapor, and the filter described herein. In some embodiments, the treatment system may contain a melter in which the radioactive waste is incorporated into a glass or metal material. The off-gas stream may comprise volatile components boiled off from the molten mixture in the melter.

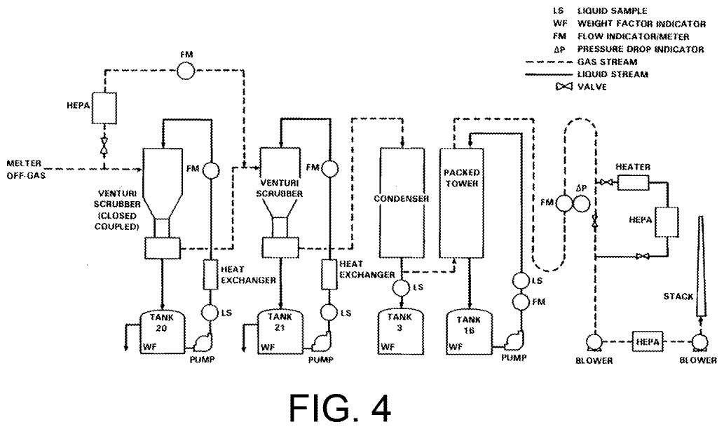

One example of an off-gas treatment system is shown in FIG. 4. As shown, the system takes the melter off-gas and uses a series of scrubbers, filters, and condensers to remove contaminants (e.g., radionuclides) from the off-gas. The system includes a series of off-gas component lines (e.g., pipes) to carry the off-gas through the treatment system. The off-gas filter can be fitted into any of these off-gas component lines. It may be fitted directly into the inside of the gas stream pipes or it may held by a separate vessel which fits in-line in one of the gas stream pipes.

In some embodiments, a cooling jacket may be provided to the outside of the filter or to the outside of the pipe containing the filter. The cooling jacket may promote condensation of the cesium on the surfaces of the filter, promoting sorption of the cesium by the cesium sorbent particles exposed on the surfaces of the filter components.

While certain embodiments of the disclosed subject matter have been described using specific terms, such description is for illustrative purposes only, and it is to be understood that changes and variations may be made without departing from the spirit or scope of the subject matter.

What is claimed is:

1. An off-gas filter comprising a polymer composition that comprises a polymeric matrix and a cesium sorbent dispersed within the matrix.

2. The off-gas filter of claim 1, wherein the cesium sorbent comprises crystalline silicotitanate particles.

3. The off-gas filter of claim 2, wherein the crystalline silicotitanate particles further comprise zirconium hydroxide.

4. The off-gas filter of claim 2, wherein the crystalline silicotitanate particles have a weight-average particle size less than 45 μm.

5. The off-gas filter of claim 1, wherein the polymer matrix comprises a polyamide.

6. The off-gas filter of claim 5, wherein the polyamide comprises PA11 and/or PA12.

7. The off-gas filter of claim 1, wherein the polymer matrix comprises a photopolymerizable polymer.

8. The off-gas filter of claim 7, wherein the polymer matrix comprises an acrylate or methacrylate polymer.

9. A system for removal of cesium from radioactive waste, the system comprising a radioactive waste material, an off-gas stream containing cesium volatilized from the radioactive waste material, and the filter of claim 1.

10. The system of claim 9, further comprising an off-gas component line containing the off-gas stream, wherein the filter is disposed in the off-gas component line.

11. A method for producing an off-gas filter, the method comprising 3D printing the filter from a polymer composition comprising a polymeric matrix and a cesium sorbent dispersed within the matrix.

12. The method of claim 11, wherein 3D printing comprises stereolithography.

13. The method of claim 12, wherein the polymer matrix comprises a photopolymerizable resin.

14. The method of claim 13, wherein the photopolymerizable resin comprises an acrylate or methacrylate polymer.

15. The method of claim 11, wherein 3D printing comprises selective laser sintering.

16. The method of claim 15, wherein the polymer matrix comprises a polyamide resin.

17. The method of claim 16, wherein the polyamide resin comprises PA11 and/or PA12.

18. The method of claim 11, wherein the cesium sorbent comprises crystalline silicotitanate particles.

19. The method of claim 18, wherein the crystalline silicotitanate particles further comprise zirconium hydroxide.

20. The method of claim 18, wherein the crystalline silicotitanate particles have a weight-average particle size less than 45 μm.
